(19) United States
(12) Patent Application Publication
(10) Pub. No.: US 2009/0156278 A1
(43) Pub. Date: Jun. 18, 2009

(54) Pivoting conveyor including a holding mechanism configurable for holding the conveyor in multiple positions

(76) Inventors: William L. Cooksey, Geneseo, IL (US); Jason R. Coppinger, Davenport, IA (US)

Correspondence Address: CNH AMERICA LLC, INTELLECTUAL PROPERTY LAW DEPARTMENT, PO BOX 1895, M.S. 641, NEW HOLLAND, PA, 17557, US

(21) Appl. No.: 12/002,506

(22) Filed: Dec. 17, 2007

(51) Int. Cl. A01F 12/46

(52) U.S. Cl. 460/114

(57) ABSTRACT

A pivoting conveyor and a mechanism easily and quickly configurable in a first manner for holding the conveyor in a first position, and in a second manner for holding the conveyor in a second position. The mechanism is connected between the conveyor housing and an adjacent structure or frame, and includes a first link pivotally connected to the frame, and a second link pivotally connected to the conveyor housing, the first link and the second link being pivotally connected at a pivotal connection. The mechanism is configured such that as the conveyor housing is in the first position, the first and second links will be in a generally aligned relationship so as to hold the conveyor housing, and the housing can be released by pivoting the second link from the aligned relationship. When the conveyor housing is in the second position, the links will be in overlapping relation so as to hold the conveyor housing, and the housing can be released by pivoting the second link. The mechanism can be operated with one hand, and can include a handle for convenience.

### TECHNICAL FIELD

This invention relates generally to a pivoting conveyor and a mechanism for holding the conveyor in fixed positions including a deployed or raised position extending upwardly, and in a lowered or stored position, the mechanism being easily configurable differently for holding the conveyor in the respective positions.

### BACKGROUND ART

Grain tanks of harvesting machines such as combines and the like are commonly located on the upper regions of the machine. The grain tank will commonly have in it a grain delivery conveyor, usually an auger type, oriented so as to extend upwardly to an outlet through which the grain conveyed by the conveyor is discharged into the tank. It is typically desirable for the outlet of the conveyor to be positionable at a relatively high elevation relative to the grain in the tank, such that the conveyor is not deeply buried in the grain in the tank, requiring it to force new grain into the tank against the weight of the existing grain above the conveyor outlet. To achieve this capability, some delivery conveyors are pivotable upwardly and downwardly and essentially ride or float on the grain in the tank, and some are fixed at a selected height. It is now common to employ upwardly extending grain tank extensions around the periphery of the tank to increase its height and thus capacity, and it is desirable for the grain delivery conveyor to extend to this additional height to provide satisfactory grain delivery.

However, some grain tank extensions make the overall height of the harvesting machine too great to allow the machine to be moved through doorways, or carried on a trailer over public roads. As a result, the extensions are variously removable, foldable or otherwise collapsible to a reduced height to accommodate this. If the grain delivery conveyor is fixed so as to extend to a height above the reduced height of the extensions, then the height of the conveyor must also be reduced. As an additional concern, if the conveyor is lowered, and is not secured in position, and thus is movable in some manner, it is foreseen that travel by the machine over rough surfaces could generate movements of the conveyor, such as bouncing movements, that could cause damage the conveyor, and/or adjacent apparatus.

Thus, what is sought is a conveyor and/or apparatus for supporting a conveyor, that provides the ability to easily and conveniently lower and raise the conveyor, and secure or hold it in both the lowered and raised positions, for instance, when lowered, to prevent the conveyor from bouncing when traveling over rough roads or fields, and possibly damaging adjacent apparatus or the conveyor itself.

### SUMMARY OF THE INVENTION

What is disclosed is a pivoting conveyor and an associated holding mechanism for supporting the conveyor, which provides the ability to easily and conveniently lower and raise the conveyor, and secure or hold it in both the lowered and raised positions, for instance, when lowered, to prevent the conveyor from bouncing when traveling over rough roads or fields, and possibly damaging adjacent apparatus or the conveyor itself.

According to a preferred aspect of the invention, the conveyor includes a tubular conveyor housing having a first end portion and an opposite second end portion, the first end portion being pivotally connected to a frame by a pivot joint for pivotal movement of the conveyor housing about a pivotal axis relative to the frame, between at least a predetermined first position and a predetermined second position angularly related to the first position. A pivoting holding mechanism of the invention is connected between the conveyor housing and the frame, the mechanism including a first link having a first end portion pivotally connected to the frame at a first pivotal connection, and a second link having a first end portion pivotally connected to the conveyor housing at a second pivotal connection. The links are pivotally connected at a third pivotal connection. The first end portion of the conveyor housing includes a stop element disposed at a predetermined location for engaging or contacting the mechanism, when in a first predetermined configuration, the stop element preferably being located along a path of pivotal movement of the second link about the second pivotal connection.

As a result, as the conveyor housing is pivoted into the first position, the first and second links will automatically pivot into the first predetermined configuration, which is a generally aligned relationship between the first pivotal connection and the second pivotal connection, so as to be operable to hold the conveyor housing in the first position. In this position, the mechanism is held against the stop element. Then, to release the conveyor, to allow pivoting it to another position, in particular, to the second position, the second link is pivoted out of the aligned relationship with the first link. Also, as the conveyor housing is pivoted to the second position, the first link and the second link will pivot into a new, overlapping relationship, so as to hold the conveyor housing in the second position. Then, when it is desired to move the conveyor, the second link can be pivoted out of the overlapping position with the first link to release the conveyor housing.

According to another preferred aspect of the invention, the conveyor comprises a grain delivery conveyor, and the first position corresponds to a lowered or stored position in a grain tank, wherein the conveyor is located in a lower region of the tank so as to extend upwardly only to about an upper edge or less of the tank, and the second position corresponds to a raised or deployed position, extending to an upper region of the tank, or to a region defined by grain tank extensions, so as to be operable for discharging grain into the upper region. As a result, in the lowered position the conveyor height is sufficiently low so as to provide adequate height clearance for transport and passage through doorways of buildings and under bridges, and in the raised position, the conveyor is of adequate height for depositing grain onto existing grain in the upper region of the tank, including when grain tank extensions are used to increase the grain capacity of the tank.

According to another preferred aspect of the invention, the mechanism includes a handle, preferably on or in connection with the second link and conveniently located, which handle can be grasped by a person using only one hand, for easily pivoting the holding mechanism between its different configurations for holding the conveyor in its different positions, and easily releasing the mechanism and conveyor for movement to the other position.

### BRIEF DESCRIPTION OF THE DRAWINGS

FIG. 1 is a simplified schematic rear view of a representative agricultural harvesting machine, including a grain delivery conveyor and holding mechanism according to the invention disposed in a grain tank of the machine for delivering grain thereto;

FIG. 2 is a fragmentary perspective view of the conveyor, mechanism and grain tank of FIG. 1, showing the conveyor held in a raised deployed position by the mechanism;

FIG. 3 is another fragmentary perspective view of the conveyor, mechanism and grain tank, showing the conveyor held by the mechanism in a lowered stored position;

FIG. 3a is a fragmentary end view of the conveyor and mechanism;

FIG. 4 is a simplified schematic representation of the conveyor in the raised position and the configuration of the mechanism for holding the conveyor in that position, and including an arrow illustrating a pivotal movement of a link of the mechanism for releasing the conveyor;

FIG. 5 is another simplified schematic representation of the conveyor and mechanism, showing the conveyor at an intermediate position between the raised and lowered positions, and showing the mechanism transitionally pivoting toward a second configuration for holding the conveyor in the lowered position; and

FIG. 6 is another simplified schematic representation of the conveyor and mechanism, showing the conveyor in the lowered position, and the mechanism configured for holding it in that position.

### DETAILED DESCRIPTION OF THE PREFERRED EMBODIMENTS

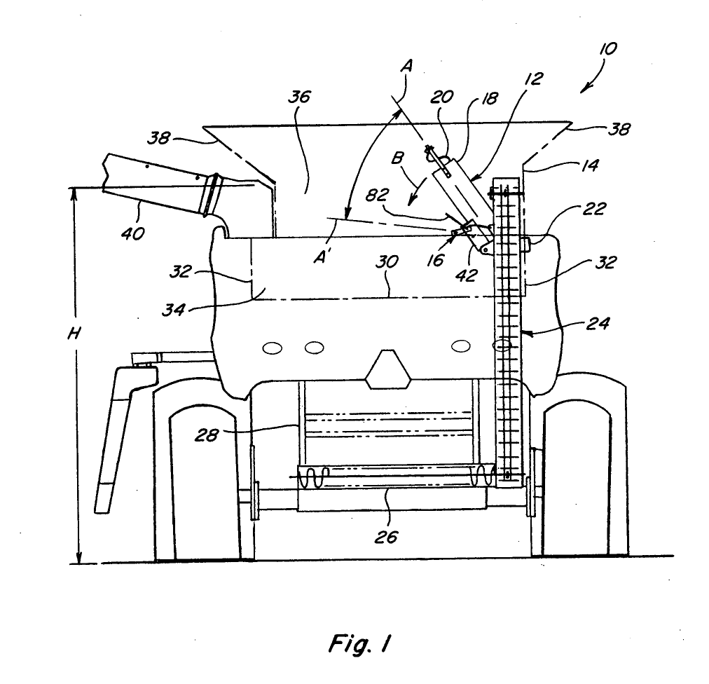

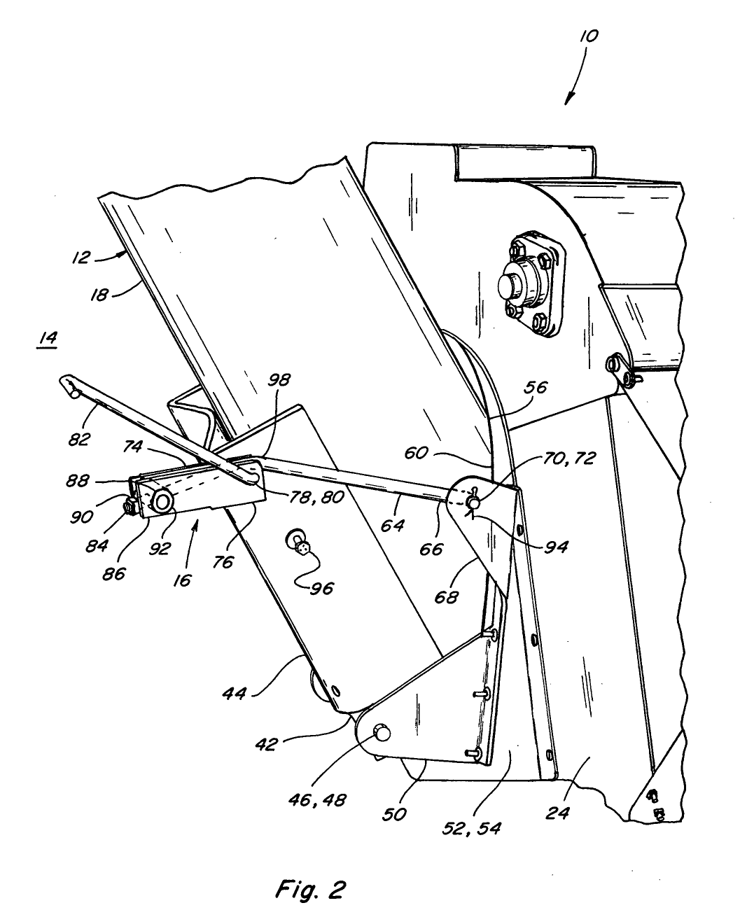

Referring now the drawings, in FIGS. 1 and 2, a representative agricultural harvesting machine 10 is shown, including a grain delivery conveyor 12 supported and held in a raised deployed position within a grain tank 14 of machine 10, by a holding mechanism 16 constructed and operable according to the teachings of the present invention. Grain delivery conveyor 12 is of conventional construction including an elongate, open ended tubular conveyor housing 18 containing a helical auger 20, connected in driven relation to a rotary drive 22 conventionally powered and operable for rotating auger 20 within housing 18 about a central rotational axis A in a direction for conveying grain (not shown) upwardly through housing 18, and discharging the grain into the interior of tank 14, in the well-known manner, as generally denoted by arrow B. The grain is received from a conventionally constructed and operable clean grain elevator 24 disposed beside grain tank 14 and operable for conveying grain upwardly to conveyor 12 from a cross conveyor 26, which receives the clean grain from a cleaning system 28 of machine 10, also in the well-known manner.

Grain tank 14 is comprised of a floor 30 and surrounding walls 32 which form an upwardly open cavity having a lower region 34 and an upper region 36. As illustrated in FIG. 1, a grain tank, such as tank 14, can include grain tank extensions 38 extending upwardly from a walls 32, either at an outwardly extending angle as shown, or straight up (not shown), which extensions can be permanent, or removable or collapsible, such as by folding (not shown), as is well known. This is advantageous as it lowers the overall height of machine 10, to facilitate transport over public roads, under overhead utility lines, bridges, and the like, and so as to allow passage through doorways of storage and service facilities. Generally, with the grain tank extensions, such as extensions 38, removed or collapsed or folded, harvesting machine 10 will have an overall height, about as denoted by arrow H. The advantage of grain tank extensions 38 when used, is that they significantly increase the grain holding capacity of grain tank 14. However, this also increases the possible elevation that grain carried in tank 14 will reach, and, as a result, it is desirable for grain delivery conveyor 12 to extend to a sufficient height within tank 14 for discharging grain onto or into existing grain in the tank, without problems. More particularly in this regard, it is contemplated that the open upper end of conveyor 12 may be fully or partially immersed in grain as it is operating, to such an extent that the grain discharged by the conveyor will be required to be forced into existing grain in the tank, and it is desirable that conveyor 12 have sufficient height to minimize such force, so as to avoid problems such as grinding, cracking, bruising or otherwise damaging the grain.

Here, the height and angular orientation of conveyor 12 within tank 14 illustrated in FIG. 1 is sufficient such that grain discharged from the conveyor into tank 14 when full or nearly full, will essentially bubble from the conveyor and intermix with the existing grain without damaging the grain. Thus, it has been found to be desirable to have the capability for securely holding conveyor 12 in this position, with the open lower end of the conveyor in mating or covering relation with an opening of an upper end of elevator 24 for receiving grain therefrom. When grain tank 14 becomes full, or it is otherwise desired to unload the tank, it will typically be unloaded using an unloading conveyor 40. This can be done either while machine 10 is operating and conveyor 12 is discharging grain into tank 14, or while machine 10 is idle.

As noted above, at some times when machine 10 is to be transported over public roads, under utility lines, bridges and the like, or is to be serviced or stored in a building, it will be desired or required to remove or collapse extensions 38, to reduce the overall height of machine 10 to about height H. Additionally, because it is evident that conveyor 12 extends upwardly beyond height H, it will also be desired or required to reduce the height of conveyor 12. Thus, it is sought to have a capability to collapse, fold or move conveyor 12 to a lower position, generally equal to or below height H.

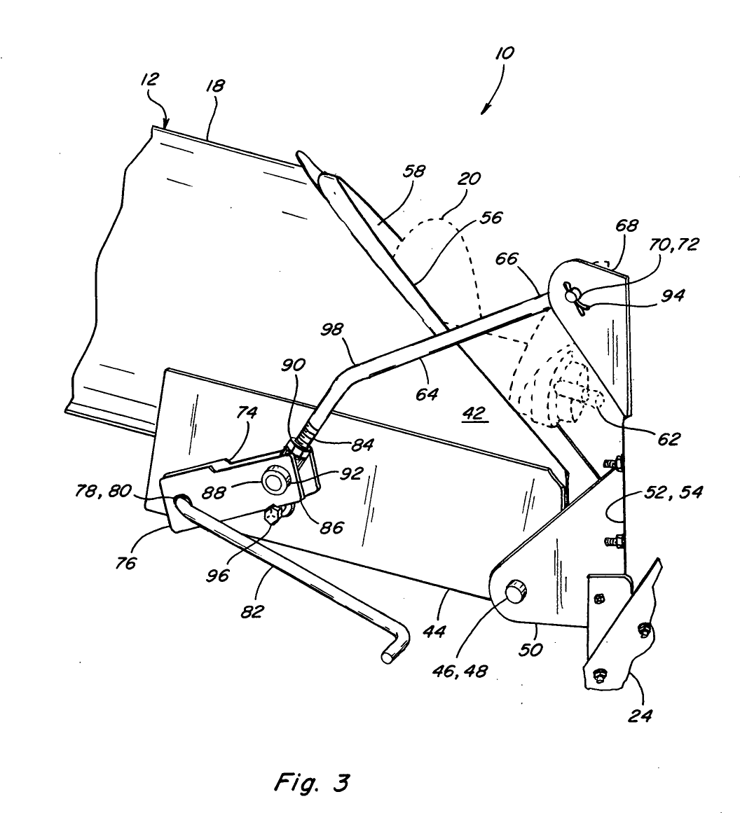

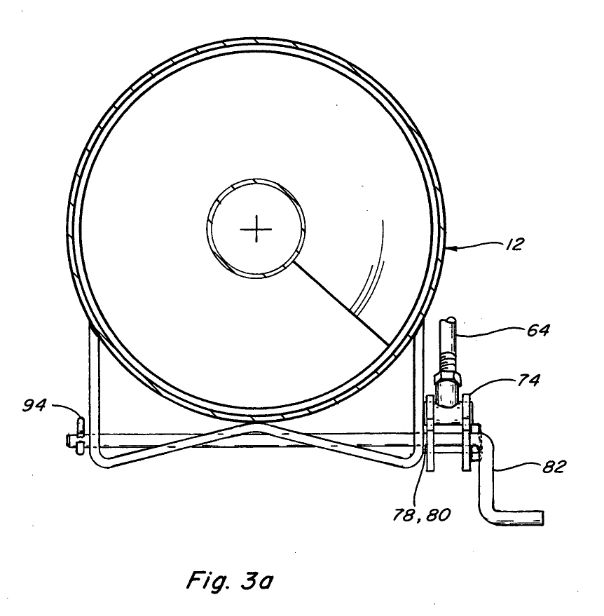

Referring also to FIGS. 3, 4, 5 and 6, holding mechanism 16 of the invention is easily configurable for securely yet releasably holding conveyor 12 in the raised deployed position illustrated in FIGS. 1 and 2, and is alternatively configurable for releasably holding conveyor 12 in a lowered stored position, as depicted by the position of axis A′ in FIG. 1, and as also illustrated in FIG. 3. Advantageously, holding mechanism 16 is adapted so as to be easily and conveniently configured in the respective holding configurations, as conveyor 12 is moved into the respective raised and lowered positions.

Here, a lower first end portion 42 of conveyor 12 or conveyor housing 18 includes a bracket 44 welded, fastened or otherwise suitably fixedly connected thereto. Bracket 44 is pivotally connected by a pivot joint 46 comprising a pivot pin 48, to a support bracket 50, fixedly mounted on a suitable structure or frame on or beside an adjacent side of grain tank 14, here, such structure or frame comprising an upper end portion 52 of a housing 54 of clean grain elevator 24. Bracket 50 can be attached to upper end portion 52 in a suitable manner also, such as by welding, fasteners, or the like. To facilitate operation, first end portion 42 of conveyor housing 18 preferably has an angled, circumferential edge portion 56 defining a lower or inlet opening 58 of conveyor 12, that is shaped to matingly engage or cover an edge portion 60 of upper end portion 52 of housing 54 of elevator 24, extending around a discharge outlet (not shown) of that conveyor, when conveyor 12 is in the raised deployed position shown in FIGS. 1 and 2, to provide a continuous, enclosed path for the transfer of grain from elevator 24, to conveyor 12. At the same time that conveyor housing 18 is mated with housing 54 of elevator 24, a drive coupler 62 of auger 20 of conveyor 12 is automatically connected in rotatably driven relation to an auger drive (not shown) in the well known manner.

Holding mechanism 16 of the invention includes an elongate first link 64, having a first end portion 66 pivotally connected to a bracket 68 on housing 54, by a first pivotal connection 70 comprising a pivot pin 72. Mechanism 16 includes a second link 74, having a first end portion 76 pivotally connected to bracket 44 on conveyor 12, by a second pivotal connection 78 comprising a first end portion 80 of a handle 82 of mechanism 16. First end portion 80 of handle 82 is fixedly connected to second link 74 at a predetermined angle, but additionally extends through and is pivotally movable relative to bracket 44, to allow joint pivotal movement of handle 82 and link 74 relative thereto. First link 64 has a second end portion 84 and second link 74 has a second end portion 86, which are pivotally connected together by a third pivotal connection 88. Here, second end portion 84 of first link 64 comprises a threaded rod end, second end portion 86 of second link 74 comprises a clevis, and pivotal connection 88 comprises a nut 90 that threadedly engages end portion 84, and a pin 92 that extends through the clevis, allowing relative pivotal movement between the rod end and the clevis. First and second pivotal connections 70 and 78 additionally include retainer pins 94. Bracket 44 includes a stop 96, which preferably extends sidewardly at a predetermined location along a path of pivotal movement of second link 74, which stop 96 can comprise a bolt mounted to the bracket with nuts, or the like. First link 64 includes a bend 98 at a predetermined location along the length thereof so as to overlap second pivotal connection 78, when conveyor 12 is in the raised position as shown in FIGS. 1 and 2.

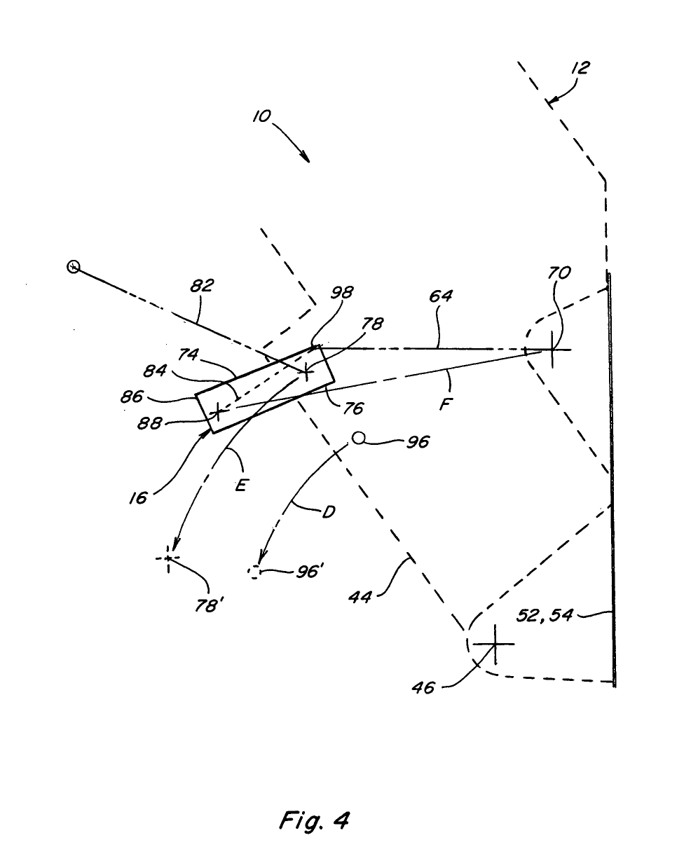

Referring more particularly to FIGS. 1, 2 and 4, with conveyor 12 positioned at its raised deployed position, first link 64 of holding mechanism will extend in overlapping relation to second link 74, to hold the conveyor in this position. More particularly, because of the location of the center of gravity of conveyor 12, and the location of the pivotal connection of conveyor 12 to bracket 50 at pivot joint 46, the weight of conveyor 12 and mechanism 16 acts to urge conveyor 12 to pivot in the counterclockwise direction about pivot joint 46, as denoted by arrow D in FIG. 4. Since second pivotal connection 78 is mounted to bracket 44 on conveyor 12, it is also urged in the counterclockwise direction, as denoted by arrow E. Because second link 74 is connected to the conveyor at pivotal connection 78, and is oriented as shown, and is connected to first link 64 at third pivotal connection 88 as also shown, the weights of conveyor 12 and mechanism 16 place second link in compression, and first link 64 in tension. Because of the shape of link 64, that is, it includes bend 98 curves downwardly about pivotal connection 78, the tensile load thereon is directed along a straight line F extending between first pivotal connection 70, and third pivotal connection 88, and below pivotal connection 78. As a result, link 64 is urged downwardly toward pivotal connection 78, by the weights. This effectively holds conveyor 12 against upper end portion 52 of housing 54, even when subjected to normal vibrations, and when harvesting machine 10 is tilted in any direction, as a result, for instance, of being located on an incline such as a hillside or the like.

When it is desired or required to release conveyor 12 from the raised deployed position, second link 74 is pivoted upwardly in the clockwise direction about second pivotal connection 78. This can be simply and easily done manually by grasping handle 82 and moving it clockwise.

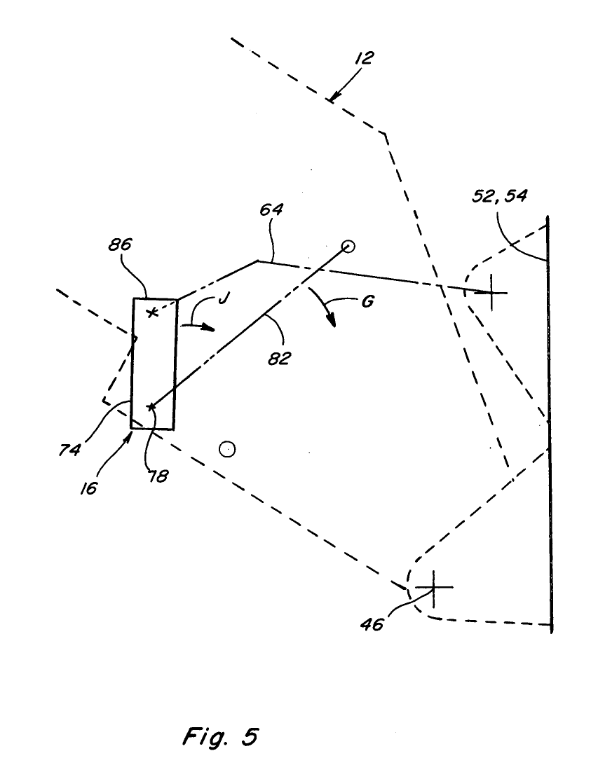

Referring also to FIG. 5, as handle 82 is pivoted further in the clockwise direction, as denoted by arrow G, second end portion 86 of second link 74 is further pivoted upwardly relative to second pivotal connection 78, as denoted by arrow J, which allows conveyor 12 to pivot counterclockwise downwardly about pivot joint 46, away from upper end portion 52 of housing 54, as illustrated. During this movement, first link 64 will be freely pivotable about first pivotal connection 70, and conveyor 12 can be manually supported.

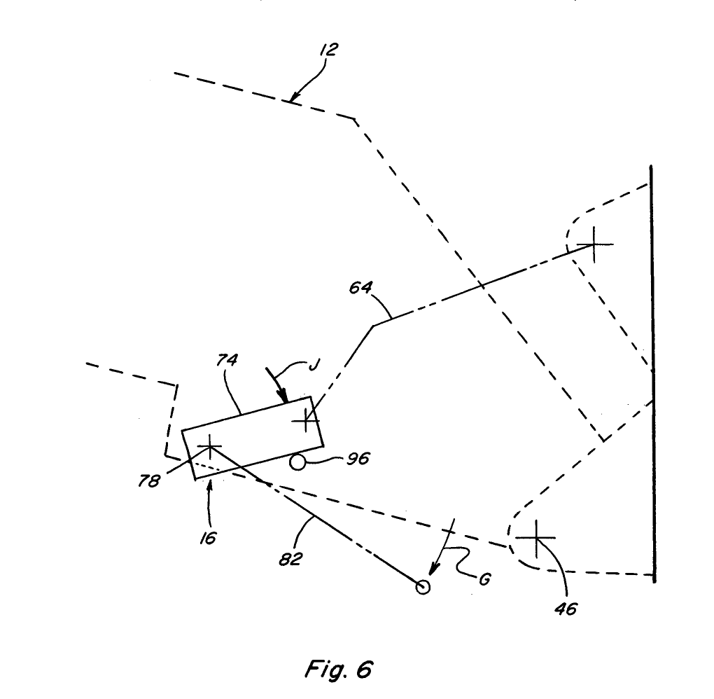

Referring also to FIG. 6, as handle 82 is moved further in the clockwise direction, as denoted by arrow G, second link 74 will be pivoted further in that direction, as denoted by arrow J. If desired, this movement can continue until link 74 comes to rest against stop 96. Conveyor 12 will now be in the lowered stored position as represented by the position and orientation of axis A′ as shown in FIG. 1. Second pivotal connection 78 will be repositioned as denoted at 78′ in FIG. 4, and stop 96 will be repositioned as denoted at 96′ in FIG. 4. Additionally, first link 64 will be positioned generally in alignment with second link 74, so as to hold mechanism 16 and conveyor 12 in this position. So held, conveyor 12 will not be able to move, particularly, to bounce, and will thus not pose a risk of damaging adjacent apparatus. Then, when it is desired to move conveyor 12, handle 82 is simply and conveniently movable upwardly in the direction opposite direction J, to release the mechanism and the conveyor. Essentially, this will move first link 64 and second link 74 out of alignment, to allow the mechanism and the conveyor to be freely pivoted.

Here, it should be noted that although mechanism 16 is illustrated and described as being manually operable, alternatively, it should be noted that, as an alternative, it could be powered, for instance by a suitable servo controller, as desired or required for a particular application. Additionally, it should be noted that although second link 74 is illustrated as being of a clevis or bifurcated construction so as to be capable of receiving first link 64 in overlapping or overlaying relation therewith, alternatively other designs that allow interlocking or overlapping of the links for holding the conveyor in the raised deployed position could be used.

Still further, referring to FIGS. 1 and 2, in the preferred embodiment of holding mechanism 16 shown, when conveyor 12 is in the raised position, handle 82 is positioned as shown, extending upwardly so as to be easily grasped with one hand as the other hand is used to support conveyor 12. The user or operator is preferably located in tank 14 to perform this operation. Conveyor 12 can then be released by pivoting handle 82 in the clockwise direction to release the conveyor, to allow it to be manually lowered. During the lowering of the conveyor, handle 82 of mechanism 16 can continue to be held, and will automatically pivot into the configuration shown in FIG. 3, with only minimal manual assistance, for holding the conveyor in the lowered position. Then, when it is desired to release the conveyor from the lowered position, handle 82 can be grasped with one hand and lifted to release the conveyor, and the conveyor can be pivoted to the raised position. Again, the handle can be held as the conveyor is pivoted, and some manual effort may be used to position the handle as shown in FIG. 3. Additionally, it should be noted that stop 96 can be positioned as desired or required for a particular application, for holding the mechanism. For instance, the stop could alternatively be positioned in the path of the first link for cooperating with the holding mechanism for holding the conveyor in the lowered position. Still further, although in the embodiment illustrated only the first link is shown as being adjustable, either the first or the second link, or both links, could be adjustable.

It will be understood that changes in the details, materials, steps, and arrangements of parts which have been described and illustrated to explain the nature of the invention will occur to and may be made by those skilled in the art upon a reading of this disclosure within the principles and scope of the invention. The foregoing description illustrates the preferred embodiment of the invention; however, concepts, as based upon the description, may be employed in other embodiments without departing from the scope of the invention. Accordingly, the following claims are intended to protect the invention broadly as well as in the specific form shown.

What is claimed is:

1. A conveyor, comprising:
a tubular conveyor housing having a first end portion and an opposite second end portion, the first end portion being pivotally connected to a frame by a pivot joint for pivotal movement of the conveyor housing about a pivotal axis relative to the frame, between a predetermined first position and a predetermined second position angularly related to the first position;
a pivoting holding mechanism connected between the conveyor housing and the frame, the mechanism comprising a first link having a first end portion pivotally connected to the frame at a first pivotal connection, and a second link having a first end portion pivotally connected to the conveyor housing at a second pivotal connection, the first link and the second link being pivotally connected at a third pivotal connection, and the first end portion of the conveyor housing including a stop element disposed at a predetermined location, wherein the mechanism is configured such that as the conveyor housing is in the first position, the first and second links will be in a generally aligned relationship between the first pivotal connection and the second pivotal connection with one of the links contacting the stop element so as to hold the conveyor housing in the first position, and when the conveyor housing is held in the first position, the second link can be pivoted out of the aligned relationship with the first link to release the conveyor housing, and such that as the conveyor housing is pivoted to the second position,
the first link and the second link will pivot into overlapping relation so as to hold the conveyor housing in the second position, and when the housing is held in the second position, the second link can be pivoted out of engagement with the first link to release the conveyor housing.

2. The conveyor of claim 1, wherein the second link comprises a handle fixedly mounted thereto, the handle being manually movable in a first direction for pivoting the second link out of the aligned relationship with the first link, and the handle being manually movable in a second direction for pivoting the second link out of the engagement with the first link.

3. The conveyor of claim 1, wherein at least one of the links has an adjustable length.

4. The conveyor of claim 1, wherein the third pivotal connection comprises a clevis and a clevis pin.

5. The conveyor of claim 4, wherein the first link comprises a curved portion that curves over a portion of the second link when the links are engaged.

6. The conveyor of claim 1, wherein the conveyor comprises a grain delivery conveyor and is located in a grain tank of an agricultural harvesting machine.

7. The conveyor of claim 6, wherein the first position comprises a lowered stored position within the grain tank, and wherein the second position comprises a raised deployed position in the tank.

8. A conveyor, comprising:
a tubular conveyor housing having a first end portion and an opposite second end portion, the first end portion being pivotally connected to a frame by a pivot joint for generally upward and downward pivotal movement of the conveyor housing about a pivotal axis relative to the frame;
a holding mechanism connected between the conveyor housing and the frame, the holding mechanism comprising a first link having a first end portion pivotally connected to the frame at a first pivotal connection, and a second link having a first end portion pivotally connected to the conveyor housing by a second pivotal connection, the first link having a second end portion pivotally connected to a second end portion of the second link at a third pivotal connection, and the first end portion of the conveyor housing including a stop element disposed at a predetermined location along a path of pivotal movement of the second link about the second pivotal connection, the mechanism being configured such that:
when the conveyor housing is pivoted downwardly to a predetermined lowered position, the holding mechanism will automatically pivot in a first pivotal direction into contact with the stop element, and the first link will pivot into a first holding position to hold the conveyor housing in the lowered position, and the second link will be pivotable in a second pivotal direction opposite the first pivotal direction to release the conveyor housing from the lowered position; and
when the conveyor housing is pivoted upwardly to a predetermined raised position angularly related to the lowered position, the second link will be automatically pivoted in the second pivotal direction into overlapping relation by the first link such that the engaged links will hold the conveyor housing in the raised position, and the second link will be pivotable in the first pivotal direction out of the engagement with the first link, to release the conveyor housing from the raised position.

9. The conveyor of claim 8, wherein the second link comprises a handle fixedly mounted thereto, the handle being manually movable in the second pivotal direction for pivoting the second link out of the aligned relationship with the first link, and the handle being manually movable in the first pivotal direction for pivoting the second link out of the overlapping relationship with the first link.

10. The conveyor of claim 8, wherein at least one of the links has an adjustable length.

11. The conveyor of claim 8, wherein the third pivotal connection comprises a clevis and a clevis pin.

12. The conveyor of claim 11, wherein the first link comprises a curved portion that curves over a portion of the second link when the links are engaged.

13. The conveyor of claim 8, wherein the conveyor comprises a grain delivery conveyor and is located in a grain tank of an agricultural harvesting machine.

14. The conveyor of claim 13, wherein the lowered position comprises a position wherein the conveyor housing is located substantially completely within a lower region the grain tank, and wherein the raised position comprises a position extending upwardly into an upper region of the tank.

15. A grain delivery conveyor for a grain tank of an agricultural combine, comprising:
a tubular conveyor housing containing a helical auger, the housing having an inlet end portion and an opposite discharge end portion, the inlet end portion being pivotally connected by a pivot joint to structure adjacent to a side of the tank so as to be pivotable generally upwardly and downwardly relative thereto about a pivotal axis;
a holding mechanism connected between the lower end portion of the conveyor housing and the structure, the holding mechanism comprising a first link having a first end portion pivotally connected to the structure at a first pivotal connection, and a second link having a first end portion pivotally connected to the conveyor housing by a second pivotal connection, the first link having a second end portion pivotally connected to a second end portion of the second link at a third pivotal connection, and the lower end portion of the conveyor housing including a stop element disposed at a predetermined location, the mechanism being configured such that:
when the conveyor housing is pivoted downwardly to a predetermined lowered position, the second link will automatically pivot in a first pivotal direction to position a portion of the mechanism in contact with the stop element, and the first link will pivot into a first holding position to hold the conveyor housing in the lowered position, and the second link will be pivotable in a second pivotal direction opposite the first pivotal direction to release the conveyor housing from the lowered position; and
when the conveyor housing is pivoted upwardly to a predetermined raised position angularly related to the lowered position, the second link will be automatically pivoted in the second pivotal direction into engagement with the first link such that the engaged links will hold the conveyor housing in the raised position, and the second link will be pivotable in the first pivotal direction out of the engagement with the first link, to release the conveyor housing from the raised position.

16. The conveyor of claim 15, wherein the second link comprises a handle fixedly mounted thereto, the handle being manually movable in the second pivotal direction for pivoting the second link out of the aligned relationship with the first link, and the handle being manually movable in the first pivotal direction for pivoting the second link out of the engagement with the first link.

17. The conveyor of claim 15, wherein the third pivotal connection comprises a clevis and a clevis pin.

18. The conveyor of claim 17, wherein the first link comprises a curved portion that curves over a portion of the second link when the links are engaged.

19. The conveyor of claim 15, wherein the lowered position comprises a position wherein the conveyor housing is located substantially completely within a lower region the grain tank, and wherein the raised position comprises a position extending upwardly into an upper region of the tank.
